(19) United States
(12) Patent Application Publication
(10) Pub. No.: US 2020/0299553 A1
(43) Pub. Date: Sep. 24, 2020

(54) CURABLE ADHESIVE COMPOSITION AS WELL AS ADHESIVE TAPES AND PRODUCTS PRODUCED THEREFROM

(71) Applicant: 3M INNOVATIVE PROPERTIES COMPANY, St. Paul, MN (US)

(72) Inventors: Wei Cui, Shanghai (CN); Hongbo Liu, Shanghai (CN); Weigang Lin, Danyang (CN); Long Yin, Shanghai (CN); Qing Wu, Shanghai (CN); Zhou Jin, Shanghai (CN)

(21) Appl. No.: 16/061,614

(22) PCT Filed: Dec. 18, 2015
(86) PCT No.: PCT/CN2015/097870

§ 371 Date: Jun. 12, 2018

(51) Int. Cl. C09J 133/06; C09J 183/06

(52) U.S. Cl. CPC C09J 133/068; C08K 5/1515; C09J 183/06

(57) ABSTRACT

UV curable adhesive compositions are provided that include 1) a UV curable poly(meth)acrylate copolymer containing monomeric units having an epoxy group wherein the poly(meth)acrylate copolymer has a glass transition temperature between −30° C. and −10° C., 2) a silsesquioxane polymer having epoxy-containing groups, and 3) a photocatalyst. UV cured adhesive compositions and adhesive tapes containing the cured adhesive compositions are also provided. The cured adhesive compositions are pressure sensitive adhesives.

### TECHNICAL FIELD

The present invention belongs to the technical field of (meth)acrylate pressure sensitive adhesives, and particularly to a curable adhesive composition as well as an adhesive tape and a product produced therefrom.

### BACKGROUND

Pressure sensitive adhesive tapes are in fact ubiquitous in homes and working spaces. A simplest structure of the pressure sensitive adhesive tape includes an adhesive composition on a backing, and the overall structure has a tacky surface at the temperature in use, and can be adhered to a variety of substrates using moderate pressure. In such a manner, the pressure sensitive adhesive tape constitutes an integrated self-held adhesion system.

According to the Pressure Sensitive Adhesive Tape Council, a pressure sensitive adhesive (PSA) is known to have the following properties: (1) it has a vigorous and persistent adhesive force; (2) it can perform the adhesion with a pressure not exceeding the finger pressure; (3) it has adequate capacity to be affixed to an adherend; and (4) it has adequate cohesive strength so as to allow it to be cleanly removed from the adherend. It has been found that a material that is given full play as a PSA includes a polymer designed and formulated to exhibit desired viscoelastic behaviors that will achieve the desirable balance among the adhesive force, peel off adhesive force and shear strength. A PSA is characterized generally by being tacky at room temperature (for example 20° C.). PSAs do not include a composition only having stickiness or only having the ability to adhere to a certain surface.

The preparation of a high-performance pressure sensitive adhesive with both high peel strength and high shear strength has been a target searched in the industry of pressure sensitive adhesives. For example, in the refrigerator industry, frameless overlay film glass doors have become a new development trend in the design and production of refrigerators. To prepare the frameless overlay film glass, it is generally required to adhere tightly and firmly a decorative film material to a flat toughened glass using an adhesive. In this application, it is required that the adhesive not only has high peel strength for a glass substrate, but also has high cohesive and shear strength, thereby to be able to maintain relatively strong bonding strength at a higher temperature (such as from 70° C. to 120° C.).

In the trade, a great many studies have been carried out in an attempt to prepare pressure sensitive adhesives and pressure sensitive adhesive tapes having high cohesive strength and shear strength while maintaining high peel strength, but the adhesives made have effects that are not particularly ideal.

### SUMMARY

Therefore, it is required that a novel pressure sensitive adhesive composition has high cohesive strength and shear strength while maintaining high peel strength.

A pressure sensitive adhesive composition and a pressure sensitive adhesive tape related in the present invention have high cohesive strength and shear strength while maintaining high peel strength.

A first aspect of the present invention provides a curable adhesive composition, i.e., a pressure sensitive adhesive composition that can be cured with UV and/or visible radiation, including (1) a UV curable poly(meth)acrylate copolymer comprising a monomeric unit having a first epoxy-containing group, wherein the poly(meth)acrylate copolymer has a glass transition temperature between −30° C. and −10° C.; the curable adhesive composition further contains (2) a silsesquioxane polymer comprising a second epoxy-containing group, wherein the silsesquioxane polymer comprises at least one three-dimensional branched network having at least three repeating units of the following formula (I)

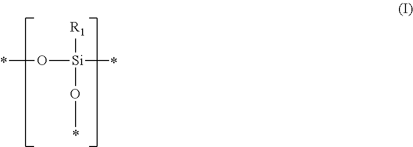

wherein, R₁ is a epoxy-containing group and the asterisk (*) stands for an attachment site to another groups within the silsesquioxane polymer; and the curable adhesive composition still further contains (3) a cationic photocatalyst.

A second aspect of the present invention provides an adhesive tape associated with the curable adhesive composition, including a substrate and the above curable adhesive composition applied on at least one surface of the substrate.

A third aspect of the present invention provides a cured adhesive composition associated with the above curable adhesive composition, wherein the cured adhesive composition is a reaction product obtained by exposing the curable adhesive composition mentioned in the first aspect of the present invention to ultraviolet and/or visible radiation.

A fourth aspect of the present invention provides a product including at least one substrate and a layer of the cured adhesive composition of the third aspect on at least one surface of the at least one substrate.

A fifth aspect of the present invention provides a method for preparing a curable adhesive composition, including: providing a UV curable poly(meth)acrylate copolymer comprising a monomeric unit having a first epoxy-containing group, wherein the content of the monomeric units having the first epoxy-containing group is greater than 0.1 wt. % and less than or equal to 1 wt. %, calculated based on the total weight of the poly(meth)acrylate copolymer as 100 wt. %, and the poly(meth)acrylate copolymer has a glass transition temperature between −30° C. and −10° C.; providing a silsesquioxane polymer comprising a second epoxy-containing group; forming a mixture containing the poly(meth)acrylate copolymer and the silsesquioxane polymer, wherein the silsesquioxane polymer has a content from 0.5 to 32 wt. %, calculated based on the total weight of the poly(meth)acrylate copolymer as 100 wt. %; and adding a cationic photocatalyst into the above mixture of the poly(meth)acrylate copolymer and the silsesquioxane polymer, wherein the cationic photocatalyst has a content not exceeding 3 wt. %, calculated based on the total weight of the poly(meth)acrylate copolymer as 100 wt. %.

A sixth aspect of the present invention provides a method of preparing a cured adhesive composition, wherein the method includes preparing a curable adhesive composition as described above in the fifth aspect and exposing the curable adhesive composition to ultraviolet and/or visible radiation to form the cured adhesive composition.

A seventh aspect of the present invention provides a curable adhesive composition that can be cured with UV and/or visible radiation, the curable adhesive composition including (1) a UV curable poly(meth)acrylate copolymer comprising a monomeric unit having a first epoxy-containing group, wherein the content of the monomeric unit having the first epoxy-containing group is greater than 0.1 wt. % and less than or equal to 1 wt. %, calculated based on the total weight of the poly(meth)acrylate copolymer as 100 wt. %, and wherein the poly(meth)acrylate copolymer has a glass transition temperature between −30° C. and −10° C.; (2) a silsesquioxane polymer comprising a second epoxy-containing group, wherein the silsesquioxane polymer has a content from 0.5 to 32 wt. %, calculated based on the total weight of the poly(meth)acrylate copolymer as 100 wt. %; and (3) a cationic photocatalyst, wherein the cationic photocatalyst has a content not exceeding 3 wt. %, calculated based on the total weight of the poly(meth)acrylate copolymer as 100 wt. %.

An eighth aspect of the present invention provides a cured adhesive composition that includes that reaction product obtained by exposing a cured adhesive composition of the seventh aspect to ultraviolet and/or visible radiation.

It has been found in the present invention that cationic cross-linking and curing of a curable adhesive composition can be achieved. The curable adhesive composition if formed by mixing a UV curable poly(meth)acrylate copolymer having a first epoxy-containing group, a silsesquioxane polymer having a second epoxy-containing group, and a cationic photocatalyst. A cured adhesive composition can be obtained by exposing the curable adhesive composition to ultraviolet and/or visible irradiation. The cured adhesive composition is a pressure sensitive adhesive.

Results indicate that the addition of only a small amount of the silsesquioxane polymer having the second epoxy-containing group into the adhesive composition can very effectively improve the adhesion performance of the adhesive composition. The silsesquioxane polymer having the second epoxy-containing group can be used as an effective macromolecular cross-linker for the poly(meth)acrylate copolymer, thereby improving cohesive strength of the adhesive composition. Additionally, the addition of the silsequioxane polymer can effectively promote the adhesion of the adhesive composition to some surfaces, such as glass.

Therefore, the pressure sensitive adhesive composition of the present invention has high cohesive strength and shear strength while maintaining high peel strength.

### DESCRIPTION OF PREFERRED EMBODIMENTS

It is to be understood that various other embodiments can be envisaged according to the teachings in the present specification and modifications to which can be made by those skilled in the art, without departing from the scope or spirit of the present invention. Therefore, the following particular embodiments have no limiting meaning.

All numbers for denoting characteristic dimension, quantity and physical characteristics used in the present specification and claims are to be understood as modified by a term “about” in all situations, unless indicated otherwise. Therefore, unless stated conversely, parameters in numerical values listed in the above specification and the claims are all approximate values, and one skilled in the art is capable of changing these approximate values appropriately, by taking advantage of the desired properties sought to be obtained in contents of the teachings disclosed herein. The use of numerical ranges represented by end points includes all numbers within that range as well as any range within that range.

### Definition of Terms

Unless indicated particularly, terms used herein have the following meanings:

The term “alkyl” refers to monovalent radical of an alkane and can be a linear, cyclic, or branched alkyl group containing a designated number of carbon atoms. The alkyl group may comprise 1 to 20, preferably 1 to 12, more preferably 1 to 8, even preferably 1 to 6 or 1 to 3 carbon atoms. Examples of alkyl include, but are not limited to, methyl, ethyl, n-propyl, iso-propyl, n-butyl, iso-butyl, tert-butyl, n-pentyl, cyclopentyl, cyclohexyl, ethylhexyl, n-octyl, n-heptyl, cycloheptyl, adamantyl, norbornyl and the like.

The term “alkylene” refers to a divalent radical of an alkane and can be a linear, cyclic, or branched alkylene group containing a designated number of carbon atoms. The alkylene group may comprise 1 to 20, preferably 1 to 12, more preferably 1 to 8, even preferably 1 to 6 or 1 to 3 carbon atoms. Examples of alkylene include, but are not limited to, methylene, ethylene, n-propylene, iso-propylene, n-butylene, iso-butylene, tert-butylene, n-pentylene, cyclopentylene, cyclohexylene, ethylhexylene, n-octylene, n-heptylene, cycloheptylene, adamantylene, norbornylene, and the like.

The term “heteroalkylene” refers to a divalent group that has two or more alkylene groups linked together with heteroatoms selected from oxygen (—O—), sulfur (—S—), or nitrogen (—NH—). The heteroalkylene often has up to 20 carbon atoms and up to 10 heteroatom, up to 16 carbon atoms and up to 8 heteroatoms, up to 12 carbon atoms and up to 6 heteroatoms, up to 10 carbon atoms and up to 5 heteroatoms, or up to 6 carbon atoms and up to 3 heteroatoms.

The description of “A and/or B” denotes that either of the situations, wherein either or both of which are present, may be occurred, i.e., the description includes three situations, “A and B,” “A” and “B”.

The description of “A to B” or “between A and B” includes a value of A, a value of B, and any value greater than A and less than B. For example, “1 to 10” includes 1, 10, and any value greater than 1 and less than 10, e.g., 2, 3, 4, 5, 6, 7, 8, 9, 2.3, 3.5, 5.26, 7.18, 9.999, and the like.

By “molecular weight”, molecular weights referred herein are all weight average molecular weights, and are all obtained by the gel gas chromatography (GPC), unless stated particularly.

The “glass transition temperature” refers to a temperature at which transformation occurs between an elastomeric state and a vitreous state of a polymer, namely a temperature at which an amorphous portion of the polymer is transformed from a frozen state to a thawed state. Unless stated particularly, the glass transition temperatures referred in the present invention are all determined by differential scanning calorimetry (DSC).

The “glass transition temperature of a monomer” refers to the glass transition temperature of a homopolymer of the corresponding monomer.

By “an amount of a substance used”, amounts or ratios of the amounts of substances used herein all refer to weights or ratios by weight, unless stated particularly.

“A content by weight percentage of B in A” means that B belongs to a part of A, and refers to the percentage of the weight of B, when the weight of A (including B) is 100%.

“A proportion by weight of B with respect to the weight of A” means that B does not belongs to A, and refers to the percentage by weight of B with respect to the weight of A, when the weight of A (excluding B) is 100%.

The description of “(meth)acrylic acid” stands for two situations, i.e., acrylic acid and methacrylic acid.

The description of “(meth)acrylate” stands for two situations, i.e., acrylate and methacrylate, namely a generic term of esters of (meth)acrylic acid (acrylic acid and methacrylic acid) and homologues thereof. For example, methyl (meth)acrylate refers to both methyl acrylate and methyl methacrylate and ethyl (meth)acrylate refers to both ethyl acrylate and ethyl methacrylate.

A “polymer” refers to a substance formed by polymerization reaction of one or more polymerizable monomers, including homopolymers, copolymers, trimers and the like.

A “copolymer” refers to a polymer formed by polymerization of at least two different polymerizable monomers, i.e., all polymers except homopolymers, including random copolymers, block copolymers, graft copolymers, alternating copolymers as well as mixtures thereof, and the like.

“Inherent viscosity” refers to reduced viscosity when the concentration of a polymer solution tends to zero, and has a quantitative relationship with the molecular weight of the polymer. The value thereof is determined by using a capillary viscometer.

The terms “poly(meth)acrylate copolymer containing a monomeric unit having a first epoxy group”, “poly(meth)acrylate copolymer having a first epoxy group”, “poly(meth)acrylate copolymer having an epoxy group”, “poly(meth)acrylate copolymer”, and other similar expressions are used interchangeably.

The terms “silsesquioxane polymer having a second epoxy-containing group”, “silsesquioxane polymer having an epoxy-containing group”, “silsesquioxane polymer”, and other similar expressions are used interchangeably.

The term “UV curable” refers to a polymeric material that can be cured (i.e., crosslinked) when exposed to ultraviolet and/or visible radiation. Typically, curing occurs when the polymeric material is exposed to ultraviolet radiation or a mixture of ultraviolet and visible radiation.

### Curable Adhesive Composition and Cured Adhesive Composition

The curable adhesive composition provided in the present invention may be used to prepared pressure sensitive adhesive tapes or pressure sensitive adhesive sheets that have high cohesive strength and shear strength while having high peel strength at room temperature. The pressure sensitive adhesive composition is a cured adhesive composition formed from the curable adhesive composition. The cured adhesive composition is formed by exposing the curable adhesive composition to ultraviolet (UV) and/or visible radiation. The pressure sensitive adhesive composition includes reaction products of the following reaction ingredients of the curable adhesive composition:
1) a UV curable poly(meth)acrylate copolymer containing a monomeric unit having a first epoxy group, wherein the poly(meth)acrylate copolymer has a glass transition temperature between −30° C. and −10° C.;
2) a silsesquioxane polymer having a second epoxy-containing group, including at least one three-dimensional branched network having at least three repeating units of the following formula (I)

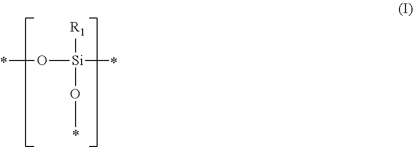

wherein, R₁ is a group comprising epoxy (R₁ is the second epoxy-containing group) and the asterisk (*) stands for an attachment site to another group within the silsequioxane polymer; and
3) a cationic photocatalyst.

### Poly(Meth)Acrylate Copolymer Containing an Epoxy Group

A poly(meth)acrylate copolymer suitable for use in the present invention is curable after exposure to ultraviolet (UV) and/or visible radiation. The poly(meth)acrylate copolymer contains an epoxy group. More particularly, the poly(meth)acrylate copolymer contains a monomeric unit having a first epoxy-containing group.

The poly(meth)acrylate copolymer containing a monomeric unit with a first epoxy-containing group has a glass transition temperature (Tg) greater than or equal to −30° C. and less than or equal to −10° C. In some examples, the poly(meth)acrylate copolymer has a glass transition temperature Tg of at least −30° C., at least −25° C., at least −20° C., or at least −15° C. In some examples, the poly(meth)acrylate copolymer has a glass transition temperature Tg of at most −10° C., at most −15° C., or at most −20° C.

The poly(meth)acrylate copolymer has an inherent viscosity from 1.15 to 1.30. In some examples, the poly(meth)acrylate copolymer has an inherent viscosity of at least 1.15, at least 1.2, or at least 1.25. In some examples, the poly(meth)acrylate copolymer has an inherent viscosity of at most 1.30, at most 1.20, or at most 1.10.

The poly(meth)acrylate copolymer has a weight average molecular weight preferably between 300,000 and 450,000 Da, and more preferably from 200,000 to 400,000 Da. In some examples, the poly(meth)acrylate copolymer has a weight average molecular weight of at least 300,000 Da, at least 350,000 Da, or at least 400,000 Da. In some examples, the poly(meth)acrylate copolymer has a weight average molecular weight of at most 450,000 Da, at most 430,000 Da, at most 400,000 Da, or at most 350,000 Da. When the poly(meth)acrylate copolymer has a weight average molecular weight less than 300,000 Da, the cohesive strength of the obtained pressure sensitive adhesive composition is influenced somewhat (e.g., the cohesive strength may decrease). When the poly(meth)acrylate copolymer has a weight average molecular weight more than 450,000 Da, the initial bonding strength of the pressure sensitive adhesive composition is influenced somewhat (e.g., the initial bonding strength may decrease).

In some examples, the content of the monomeric units having the first epoxy group within the poly(meth)acrylate copolymer is from 0.1 to 1 wt. %, based on the total weight of the poly(meth)acrylate copolymer as 100 wt. %. In some examples, the content of the monomeric units having the first epoxy group within the poly(meth)acrylate copolymer is at least 0.1 wt. %, at least 0.2 wt. %, at least 0.5 wt. %, or at least 0.8 wt. %, based on the total weight of the poly(meth)acrylate copolymer as 100 wt. %. In some examples, the monomeric units having the first epoxy group within the poly(meth)acrylate copolymer is at most 1 wt. %, at most 0.9 wt. %, at most 0.7 wt. %, or at most 0.5 wt. %, based on the total weight of the poly(meth)acrylate copolymer as 100 wt. %. If the content of the monomeric units having the first epoxy group is too high, the cured adhesive composition may have reduced peel strength because of increased crosslinking density.

The poly(meth)acrylate copolymer suitable for use in the present invention comprises a monomeric unit having a first epoxy-containing group. Such poly(meth)acrylate copolymers can be cured by exposure to UV and/or visible radiation. When exposure to UV and/or visible radiation, the epoxy group of the poly(meth)acrylate copolymer is capable of ring opening, thereby forming a cross-linked network with other components in the curable adhesive composition, for example, a semi-interpenetrating or full-interpenetrating polymer network (IPN).

The poly(meth)acrylate copolymers are usually synthesized by combining a monomer having a first epoxy-containing group with other monomers such as with other monomers with an ethylenically unsaturated group. In many embodiments, the poly(meth)acrylate copolymer is formed by copolymerizing (1) a monomer having a first epoxy-containing group and (2) another monomer that is often a (meth)acrylate ester monomer or a mixture of one or more (meth)acrylate ester monomers and a (meth)acrylic acid.

As non-limiting examples, the (meth)acrylate ester monomer may be: C1-C10 alkyl acrylate, C3-C8 cycloalkyl acrylate, C6-C12 aryl acrylate, C1-C10 alkyl methacrylate, C3-C8 cycloalkyl methacrylate, or C6-C12 aryl methacrylate, wherein the C1-C10 alkyl, C3-C8 cycloalkyl and C6-C12 aryl groups may be substituted with one or more substituents independently selected from the group consisting of hydroxy, amino, carboxyl, alkoxy (i.e., a group of formula —OR where R is alkyl), or aryloxy (i.e., a group of formula —O—Ar were Ar is an aryl). Examples of C1-C10 alkyl acrylate include, but are not limited to methyl acrylate, ethyl acrylate, propyl acrylate, isopropyl acrylate, butyl acrylate, isobutyl acrylate, tertbutyl acrylate, hexyl acrylate, and the like. Examples of C1-C10 alkyl methacrylate include, but are not limited to, methyl methacrylate, ethyl methacrylate, propyl methacrylate, isopropyl methacrylate, butyl methacrylate, isobutyl methacrylate, tert-butyl methacrylate, hexyl methacrylate and the like. Examples of C3-C8 cycloalkyl acrylate include, but are not limited to cyclopropyl acrylate, cyclobutyl acrylate, cyclopentyl acrylate, cyclohexyl acrylate, and the like. Examples of C3-C8 cycloalkyl methacrylate include, but are not limited to cyclopropyl methacrylate, cyclobutyl methacrylate, cyclopentyl methacrylate, cyclohexyl methacrylate, and the like. Examples of C6-C12 aryl acrylate include, but are not limited to phenyl acrylate, naphthyl acrylate, and the like. Examples of C6-C12 aryl methacrylate include, but are not limited to phenyl methacrylate, naphthyl methacrylate, and the like. In some embodiments, C1-C10 alkyl is preferably C1-C6 alkyl, C3-C8 cycloalkyl is preferably C3-C6 cycloalkyl, and C6-C12 aryl is preferably C6-C10 aryl.

Any suitable monomer having an ethylenically unsaturated group plus an epoxy group can be used as the monomer having the first epoxy-containing group. In many embodiments, the monomer having the first epoxy-containing group is of formula (V).

H₂C═CR₈—(CO)—OR₉ (V)

In Formula (V), the group R₈ is hydrogen or methyl and group R₉ is an epoxy-containing group. In some examples, the epoxy-containing group R₉ is of formula (II) or (III)

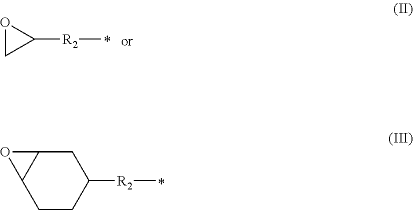

wherein, R₂ is an alkylene group or a heteroalkylene group having at least one oxygen heteroatom. In some embodiments, the R₂ alkylene group has 1 to 10 carbon atoms, 1 to 6 carbon atoms, or 1 to 4 carbon atoms and the R₂ heteroalkylene group has 1 to 10 carbon atoms, 1 to 6 carbon atoms, or 1 to 4 carbon atoms and up to 5, up to 4, up to 3, up to 2, or 1 heteroatom. The heteroatom is often oxygen. The asterisk (*) indicates where this group is attached to the rest of the monomer.

Some example monomers of formula (V) include, but are not limited to, glycidyl acrylate, glycidyl methacrylate (GMA), and (3,4-epoxy-cyclohexylmethyl) acrylate (ECA).

Some example poly(meth)acrylate copolymers are prepared from a polymerizable composition containing 0.1 to 1 wt. % of the monomer having the first epoxy-containing group (e.g., the monomer is of formula (V)), 0 to 10 wt. % (meth)acrylic acid, and 89 to 99.9 weight percent of a (meth)acrylate ester monomer. Other example poly(meth)acrylate copolymers are prepared from a polymerizable composition containing 0.1 to 1 wt. % of the monomer having the second epoxy-containing group, 1 to 10 wt. % (meth)acrylic acid, and 89 to 98.9 weight percent of a (meth)acrylate ester monomer. The wt. % are based on the total weight of the poly(meth)acrylate copolymer as 100 wt. %. In some embodiments, the (meth)acrylate ester monomer is an alkyl (meth)acrylate.

The (meth)acrylate polymer used as the poly(meth)acrylate copolymer may be obtained by copolymerization of a mixture of monomers. The mixture includes at least one monomer having a first epoxy-containing group. In some embodiment, the monomers are a mixture of one or more alkyl (meth)acrylates and a (meth)acrylate monomer having a first epoxy-containing group. In other embodiments, the monomers are a mixture of one or more alkyl (meth)acrylates, (meth)acrylic acid, and a (meth)acrylate monomer having a first epoxy-containing group. The (meth)acrylate monomer having a first epoxy-containing group is often glycidyl acrylate, glycidyl methacrylate (GMA), (3,4-epoxy-cyclohexylmethyl) acrylate (ECA). Some specific poly(meth)acrylate copolymers are poly(meth)acrylate copolymers formed from a monomer mixture of methyl acrylate, butyl acrylate, (meth)acrylic acid, and glycidyl methacrylate.

The poly(meth)acrylate copolymer may be obtained by free radical polymerization. For example, the poly(meth)acrylate copolymer may be synthesized by a traditional method of solvent free radical polymerization. Solvents that may be used include, but are not limited to ester, alcohol, ketone, carboxylic acid, aliphatic hydrocarbon, cyclane, haloalkane, aromatic hydrocarbon and the like. Specific examples thereof include, but are not limited to, ethyl acetate, n-butanol, acetone, acetic acid, benzene, toluene, ethylbenzene, cumene, tert-butylbenzene, heptane, cyclohexane, chloro-n-butane, bromo-n-butane, iodo-n-butane and the like, and any one of, or a mixture of more than two of which may be used.

Initiators for the free radical polymerization are often azo initiators, peroxy initiators, or persulfate. Any known free radical initiator can be used. Some of the initiators are thermal initiators (they are triggered by application of heat) and some of the initiators are photo initiators (they are triggered by a certain wavelength of light such as radiation in the UV region of the electromagnetic spectrum. Example initiators include, but are not limited to, azodiisobutyronitrile (AIBN), azobisisoheptonitrile (ABVN), 2,2′-azo-bi(2-methylbutyronitrile) (AMBN), benzoyl peroxide (BPO), persulfate and the like.

There is no particular limitation on the method for preparing the poly(meth)acrylate copolymer. Suitable method include, for example, a solution polymerization method, a suspension polymerization method, and an emulsion polymerization method. Polymerization can occur by exposing the polymerizable composition to UV and/or visible radiation, or to electron beam radiation.

Examples of poly(meth)acrylate copolymers include, for example, those commercially available from 3M Company (Saint Paul, Minn., USA) under the trade designation 200MP and 300LSE. Other suitable poly(meth)acrylate copolymers are also commercially available, for example, under the trade designation CSA9005X from 3M Jinshan Factory (China).

### Silsesquioxane Polymer Containing an Epoxy Group

The silsesquioxane polymer containing a second epoxy-containing group suitable for use in the present invention includes at least one three-dimensional branched network having at least three repeating units of the following formula (I);

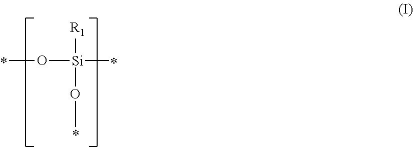

wherein, R₁ is the second epoxy-containing group; and * stands for an attachment site to another groups with the silsesquioxane polymer.

In some examples, the R₁ group that is the second epoxy-containing group is of the following formula (II) or (III):

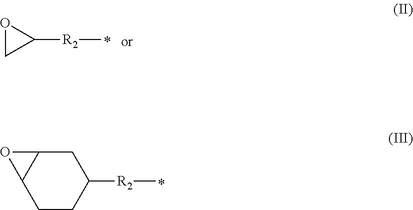

wherein, R₂ is an alkylene group having at least one oxygen heteroatom or a heteroalkylene group. In some embodiments, the group R₁ is selected from Formula (II) and R₂ is a heteroalkyl having 2 to 6 carbon atoms or 4 carbon atoms and one oxygen heteroatom. An example epoxy-containing group of formula (II) is 3-gylcidoxypropyl (which also can be referred to as 3-(oxiranylmethoxy) propyl). An example epoxy-containing group of formula (III) is 2-(3,4-epoxycylohexyl)ethyl with R₂ being an alkylene having 2 carbon atoms.

The silsesquioxane polymer can be prepared by preparing an aqueous solution of an epoxy-containing silane and heating the solution at an elevated temperature (e.g., 70° C.) for at least 15 minutes, at least 30 minutes, at least 60 minutes, or at least 120 minutes. The epoxy-containing silane is often of formula (VI).

R₁—Si(R₁₀)₃ (VI)

Group R1 is of formula (I) or (II) above. Group R₁₀ is an alkoxy group having 1-4 carbon atoms. Group R₁₀ is often methoxy, ethoxy, or propoxy. Suitable silanes of formula (VI) include, but are not limited to, 3-glycidoxypropyltrimethoxysilane (which is also referred to as 3-(oxiranylmethoxy) propyltrimethoxysilane, 3-glycidoxypropyldimethoxymethylsilane, (3-glycidoxypropyl) dimethylethoxysilane, 2-(3,4-epoxycyclohexyl) ethyltrimethoxysilane, and 2-(3,4-epoxycyclohexyl) ethyltriethoxysilane.

The silsesquioxane containing epoxy is obtained by hydrolytic condensation of the above silane monomers, during which synthesis, a silane blocking agent is often added therein to control molecular weight of the final product. The silane blocking agent has a general formula (VII).

Si(R₅)_{(4-y)}(OR₆)_{y} (VII)

In Formula (VII), group R₅ is an alkyl containing 1 to 4 carbon atoms, R₆ is hydrogen or an alkyl containing 1 to 4 carbons, and y is equal to 1, 2, or 3. Based on 100 wt. % by mass of the silane monomer added in the synthesis process, the blocking agent is used in an amount of at least 0 wt. % and at most 50 wt. %. In some embodiments, the blocking agent is dimethyldimethoxysilane.

In many embodiments, the silsequioxiane containing epoxy groups does not contain any groups that can undergo free radical polymerization reactions such as vinyl groups or (meth)acryloyl groups.

In some examples, the silsesquioxane polymer has the following formula (IV):

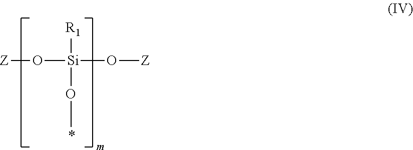

wherein group Z is hydrogen or a group having a structure of —Si(R₃)₍₃₋ₓ₎(R₄)ₓ. Group R₃ is alkyl and group R₄ is an oxygen-containing group that links group Z to a second silicon atom in the silsesquioxane polymer. The variable x is an integer having a value of 0, 1, or 2 and the variable m is an integer greater than or equal to 3.

The silsesquioxane polymer has a glass transition temperature (Tg) greater than or equal to −50° C. and less than or equal to 0° C. In some examples, the silsesquioxane polymer has a Tg of at least −50° C., at least −40° C., at least −30° C., at least −20° C., or at least −10° C. In some examples, the silsesquioxane polymer has a Tg of at most 0° C., at most −10° C., at most −15° C., at most −20° C., or at most −30° C.

The silsesquioxane polymer has a weight average molecular weight between 1,000 Da and 50,000 Da. If the silsesquioxane polymer has a weight average molecular weight lower than 1,000 Da, the pressure sensitive adhesive composition obtained often lacks sufficient cohesion at elevated temperature (e.g., 70° C. to 100° C.). The weight average molecular weight of the silsesquioxane polymer containing the epoxy group should not be too high, or else the compatibility with the poly(meth)acrylate copolymer will be deteriorated, forming a macro structure of phase separation, and negatively impacting the stability of the pressure sensitive adhesive produced. In some examples, the silsesquioxane polymer has a weight average molecular weight of at least 1,000 Da, at least 5,000 Da, at least 10,000 Da, or at least 20,000 Da. In some examples, the silsesquioxane polymer has a weight average molecular weight of at most 50,000 Da, at most 45,000 Da, at most 40,000 Da, at most 35,000 Da, or at most 30,000 Da.

### Cationic Photocatalyst

Photocatalysts for use in the present invention are activated by a photochemical method (i.e., by a photochemical reaction) using radiation with a wavelength within a UV and/or visible region of the electromagnetic spectrum. The photocatalyst is often an onium salt or a cationic organometallic salt. Such photocatalysts are further described, for example, in U.S. Pat. No. 5,709,948 (Perez et al.) and in US Patent Application Publication 2002/0182955 (Weglewski et al.).

Onium salt photocatalyst are often diazonium complex salts, iodonium complex salts, or sulfonium complex salts. The iodonium complex salts are often diaryl iodonum salts and the sulfonium salts are often triaryl sulfonium complex salts. The aryl groups can be carbocylic or can include a heteroatom. Example aryl groups include, but are not limited to, phenyl, thienyl, furanyl, and pyrazolyl groups. Any of these aryl groups can further include a fused benzo ring such as, for example, naphthyl, benzothienyl, benzofuranyl, and benzopyrazolyl. Examples of suitable anions for the complex salts include, but are not limited to, BF₄⁻, PF₆⁻, SbF₆⁻, FeCl₄⁻, SnCl₅⁻, AsF₆⁻, SbF₅OH⁻, SbCl₆⁻, SbF₅⁻², AlF₅⁻², GaCl₄⁻, InF₄⁻, TiF₆⁻², ZrF₆⁻, and CF₃SO₃⁻. The anions are advantageously BF₄⁻, PF₆⁻, SbF₆⁻, AsF₆⁻, SbF₅OH⁻, or SbCl₆⁻. In some embodiments, the anions are SbF₆⁻, AsF₆⁻, PF₆⁻, and SbF₅OH⁻. Some particularly preferred anions are often SbF₆⁻ and PF₆⁻. Various iodonium complex salts and sulfonium complex salts are further listed and described in U.S. Pat. No. 4,256,828 (Smith) and 4,173,476 (Smith et al.). In some embodiments, the photocatalyst is a sulfonium salt such as, for example, triphenyl sulfonium hexafluoroantimonate or p-phenyl(thiophenyl)biphenyl sulfonium hexafluoroantimonate, An example sulfonium complex salt is commercially available under the trade designation DOUBLECUR 1176 from Double Bond Chemical Ind. Co., Ltd.

Another type of photocatalyst suitable for use in the present invention comprises photoactivatable organic metal coordination salts, such as those described in U.S. Pat. No. 5,059,701 (Keipert) and 5,191,101 (Palazzotto et al.). The organic metal coordination salts are often cyclopentadienyliron(II) arene cation complex salts. Examples include, but are not limited to, [(η⁶-benzene)(η⁵-cyclopentadienyl)Fe]⁺[SbF₆]⁻, [(η⁶-toluene)(η⁵-cyclopentadienyl)Fe]⁺[AsF₆]⁻, [(η⁶-xylene)(η⁵-cyclopentadienyl)Fe]⁺[SbF₆]⁻, [(η⁶-isoproplylbenzene)(η⁵-cyclopentadienyl)Fe]⁺[PF₆]⁻, [(η⁶-xylene(mixed isomers))(η⁵-cyclopentadienyl)Fe]⁺[SbF₆]⁻, [(η⁶-xylene(mixed isomers))(η⁵-cyclopentadienyl)Fe]⁺[PF₆]⁻, [(η⁶-orthoxylene)(η⁵-cyclopentadienyl)Fe]⁺[CF₃SO₃]⁻, [(η⁶-metaxylene)(η⁵-cyclopentadienyl)Fe]⁺[BF₄]⁻, [(η⁶-1,3,5-trimethyl benzene)(η⁵-cyclopentadienyl)Fe]⁺[SbF₆]⁻, [(η⁶-hexamethyl benzene)(η⁵-cyclopentadienyl)Fe]⁺[SbF₅OH]⁻, and [(η⁶-fluorene)(η⁵-cyclopentadienyl)Fe]⁺[SbF₆]⁻. IRGACURE 261 is a trade designation for an example cyclopentadienyliron(II) arene organic metal coordination salt that is commercially available from BASF.

### Preparation of Curable Adhesive Composition

The curable adhesive composition of the present invention is prepared by a method including: (1) providing an poly(meth)acrylate copolymer comprising a monomeric unit having a first epoxy-containing group; (2) providing a silsesquioxane polymer comprising a second epoxy-containing group; and (3) mixing the poly(meth)acrylate adhesive and the silsesquioxane polymer; and (4) adding a cationic photocatalyst to the mixture.

The silsesquioxane polymer is mixed with the poly(meth)acrylate copolymer. The content of the sisesquioxane polymer in the mixture is from 0.5 to 32 wt. %, calculated with the total weight of the poly(meth)acrylate copolymer as 100 wt. %. In some examples, the content of silsesquioxane polymer in the mixture is at least 0.5 wt. %, at least 1 wt. %, at least 5 wt. %, at least 10 wt. %, or at least 15 wt. % based on the total weight of the poly(meth)acrylate copolymer as 100 wt. %. In some examples, the content of the silsesquioxane polymer is at most 30 wt. %, at most 25 wt. %, or at most 20 wt. %, based on the total weight of the poly(meth)acrylate copolymer as 100 wt. %. When the silsesquioxane polymer has a content less than 0.5 wt %, it may fail to effectively improve cohesive strength of the poly(meth)acrylate copolymer, and when the silsesquioxane polymer has a content more than 32 wt %, the system may have increased crosslinking density but decreased peel strength. Further, it the silsesquioxane polymer content is more than 32 wt %, the ability to form a layer or film of the curable adhesive composition may decrease.

The cationic photocatalyst is used in an amount depending on the formula employed and performance required to be achieved. In some examples of the present invention, the suitable content of the cationic photocatalyst is from 0.01 to 3 wt. %, based on the total weight of the poly(meth)acrylate copolymer as 100 wt. %. In some examples, the content of the cationic photocatalyst is at least 0.01 wt. %, at least 0.05 wt. %, at least 0.1 wt. %, at least 0.5 wt. %, at least 1 wt. %, or at least 1.5 wt. %, based on the total weight of the poly(meth)acrylate copolymer as 100 wt. %. In some examples, the suitable cross-linker has a content of at most 3 wt. %, at most 2 wt. %, at most 1.5 wt. %, at most 1 wt. %, or at most 0.5 wt. %, based on the total weight of the poly(meth)acrylate copolymer as 100 wt. %.

Overall, the curable adhesive compositions often contain poly(meth)acrylate copolymer, the silsequioxane polymer in an amount in a range of 0.5 to 32 wt. % based on the total weight of the poly(meth)acrylate copolymer as 100 wt. %, and the cationic photocatalyst in an amount not exceeding 3 wt. % based on the total weight of the poly(meth)acrylate copolymer as 100 wt. %.

In some embodiments, the curable adhesive composition further includes an organic solvent. Any suitable organic solvent can be use such as, for example, ethyl acetate. The curable adhesive composition can include up to 77.5 wt % organic solvent based on the total weight of the poly(meth)acrylate copolymer and the organic solvent as 100 wt. %.

### Preparation of Pressure Sensitive Adhesive Tapes

The curable adhesive composition can be formed by exposing the curable adhesive composition to ultraviolet and/or visible radiation. Exposure to UV and/or visible radiation results in crosslinking reactions. In many embodiments, the curable adhesive composition is a solution that can be coated onto a suitable support, for example, a flexible backing. Preferably, the curable adhesive composition is coated shortly after the preparation. Exposure to UV and/or visible radiation occurs after coating the curable adhesive composition onto the support. The cured adhesive composition is a pressure sensitive adhesive.

Examples of materials that may be used in the solid support (e.g., flexible backing) include polyolefins, such as polyethylene, polypropylene (including isotactic polypropylene), polystyrene, polyester, polyvinyl alcohol, poly(ethylene terephthalate), poly(butylene terephtalate), poly(caprolactam), poly(vinylidene fluoride), polylactide, cellulose acetate and ethyl cellulose, and the like. The surface of the solid support, if desired, may also bear a specific micro-replicated structure, as described in U.S. patents U.S. Pat. No. 5,141,790 (Calhoun et al.), U.S. Pat. No. 5,296,277 (Wilson et al.) and U.S. Pat. No. 5,362,516 (Wilson et al.), and the like.

The backing may also be prepared from a textile, for example, a textile formed from threads of a synthetic or natural material such as cotton, nylon, rayon, glass, ceramic materials and the like, or a nonwoven cloth such as air lay of natural or synthetic fibers, or mixtures thereof. The backing may also be formed from metal, metallized polymer films, or a ceramic sheet may be in any conventional known product forms, such as tags, adhesive tapes, billboards, covers, labels and the like, in which it is utilized together with the pressure sensitive adhesive composition.

The pressure sensitive adhesive composition according to the present invention can provide a transfer adhesive film, having a release paper (film) on at least one surface that can be used in the subsequent adhesion. Alternatively, it is a single-sided or double-sided adhesive tape, containing a layer of a substrate therein. The substrate may be a plastic material, such as polyethylene, polypropylene (including isotactic polypropylene), polystyrene, polyester, polyvinyl alcohol, poly(ethylene terephthalate), poly(butylene terephthalate), or alternatively may be the above plastic material metallized, or alternatively nonwoven clothes or metallized nonwoven clothes, metal foils or a laminated film of a metal foil with the above plastic material, alternatively a foam, such as an acrylate foam, a polyethylene foam, a polyurethane foam and a neoprene foam, and the like. The foam may be coextruded together with the adhesive, or may be attached to one surface or both surfaces of the foam.

Examples of the release paper (film) are well known in the art, and include for example organosilicon coated kraft paper, glassine papers or cast moulded kraft paper, poly(ethylene terephthalate) film and the like (available from Monadnock Paper Industry Company, Wisconsin, USA; Loparex Paper Industry Company, Shanghai City; and the like). Adhesive tapes of the present invention may also be blended into the low-viscosity backsize (LAB) known in the art.

Coating approaches that may be employed in the present invention include, but are not limited to, roller coating, flow coating, dip coating, spin coating, spray coating, blade coating, mould coating and the like. These different coating methods allow the composition to be arranged on the substrate in variable thickness, thereby to allow the composition to have a broader usable range. The coating thickness may be varied, with a common coating thickness of the dried adhesive from 2 to 500 μm (micrometers), more preferably from 25 to 250 μm.

The present invention includes particular embodiments of the following various items:

Item 1 is a curable adhesive composition including (1) a UV curable poly(meth)acrylate copolymer comprising a monomeric unit having a first epoxy-containing group, wherein the poly(meth)acrylate copolymer has a glass transition temperature between −30° C. and −10° C.; the curable adhesive composition further contains (2) a silsesquioxane polymer comprising a second epoxy-containing group, wherein the silsesquioxane polymer comprises at least one three-dimensional branched network having at least three repeating units of the following formula (I)

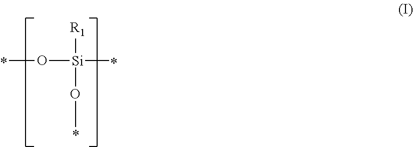

wherein, R₁ is a epoxy-containing group and the asterisk (*) stands for an attachment site to another groups within the silsesquioxane polymer; and the curable adhesive composition still further contains (3) a cationic photocatalyst.

Item 2 is the curable adhesive composition of item 1, characterized in that, the first epoxy-containing group or the second epoxy-containing group have structures of the following formula (II) or formula (III):

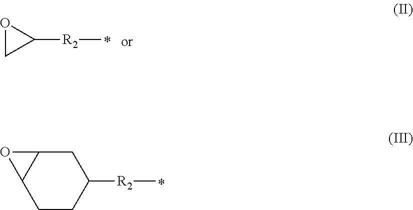

wherein, R₂ is an alkylene group or a heteroalkylene group having at least one oxygen heteroatom.

Item 3 is the curable adhesive composition of item 1 or 2, characterized in that, the silsesquioxane polymer comprising the second epoxy-containing group has the following formula (IV):

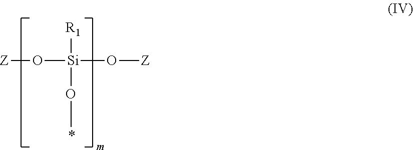

wherein, Z is hydrogen or a group having a structure of —Si(R₃)₍₃₋ₓ₎(R₄)ₓ. Group R₃ is alkyl; group R₄ is hydroxy, or an oxygen-containing group linking group Z to second silicon atom in the silsesquioxane polymer; x is an integer with a value of 0, 1, or 2; and m is an integer greater than or equal to 3.

Item 4 in the curable adhesive composition of any one of items 1 to 3, characterized in that, the content of the monomeric unit having the first epoxy-containing group is greater than 0.1 and less than or equal to 1 wt. %, calculated based on the total weight of the poly(meth)acrylate copolymer as 100 wt. %.

Item 5 is the curable adhesive composition of any one of items 1 to 4, characterized in that, the poly(meth)acrylate copolymer has a glass transition temperature between −25° C. and −10° C.

Item 6 is the curable adhesive composition of any one of items 1 to 5, characterized in that, the poly(meth)acrylate copolymer has a glass transition temperature between −20° C. and −15° C.

Item 7 is the curable adhesive composition of any one of items 1 to 6, characterized in that, the poly(meth)acrylate copolymer has a weight average molecular weight between 300,000 and 450,000 Da.

Item 8 is the curable adhesive composition of any one of items 1 to 7, characterized in that, the silsesquioxane polymer has a content from 5 to 25 wt. %, calculated based on the total weight of the poly(meth)acrylate copolymer as 100 wt. %.

Item 9 is the curable adhesive composition of any one of items 1 to 8, characterized in that, the silsesquioxane polymer has a content from 5 to 15 wt. %, calculated based on the total weight of the poly(meth)acrylate copolymer as 100 wt. %.

Item 10 is the curable adhesive composition of any one of items 1 to 9, characterized in that, the silsesquioxane polymer has a weight average molecular weight from 1,000 to 50,000 Da and a glass transition temperature greater than −40° C. and less than or equal to 10° C.

Item 11 is the curable adhesive composition of any one of items 1 to 10, characterized in that, the cationic photocatalyst has a content from 1 to 3 wt. %, calculated based on the total weight of the poly(meth)acrylate copolymer as 100 wt. %.

Item 12 is the curable adhesive composition of any one of items 1 to 11, characterized in that, the cationic photocatalyst includes at least one of the following compounds: onium salt or a cationic organometallic salt.

Item 13 is an adhesive tape comprising a substrate and a curable adhesive composition of any one of Items 1 to 12 applied to at least one surface of the substrate.

Item 14 is a cured adhesive composition comprising a reaction product obtained by exposing a curable composition of any one of items 1 to 12 to ultraviolet and/or visible radiation.

Item 15 is an article comprising at least one substrate and a layer of the cured adhesive composition of item 14 on at least one surface of the at least one substrate.

Item 16 is a method for preparing a curable adhesive composition. The method includes providing a UV curable poly(meth)acrylate copolymer comprising a monomeric unit having a first epoxy-containing group, wherein the content of the monomeric units having the first epoxy-containing group is greater than 0.1 wt. % and less than or equal to 1 wt. %, calculated based on the total weight of the poly(meth)acrylate copolymer as 100 wt. %, and the poly(meth)acrylate copolymer has a glass transition temperature between −30° C. and −10° C.; providing a silsesquioxane polymer comprising a second epoxy-containing group; forming a mixture containing the poly(meth)acrylate copolymer and the silsesquioxane polymer, wherein the silsesquioxane polymer has a content from 0.5 to 32 wt. %, calculated based on the total weight of the poly(meth)acrylate copolymer as 100 wt. %; and adding a cationic photocatalyst into the above mixture of the poly(meth)acrylate copolymer and the silsesquioxane polymer, wherein the cationic photocatalyst has a content not exceeding 3 wt. %, calculated based on the total weight of the poly(meth)acrylate copolymer as 100 wt. %.

Item 17 is the method of item 16, wherein the silsesquioxane polymer comprises at least one three-dimensional branched network having at least three repeating units of the following formula (I)

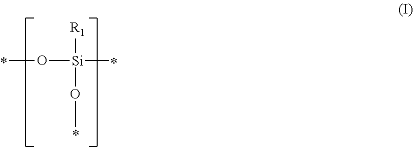

wherein, R₁ is a epoxy-containing group and the asterisk (*) stands for an attachment site to another groups within the silsesquioxane polymer.

Item 18 is the method of item 16 or 17, characterized in that, the first epoxy-containing group or the second epoxy-containing group have structures of the following formula (II) or formula (III):

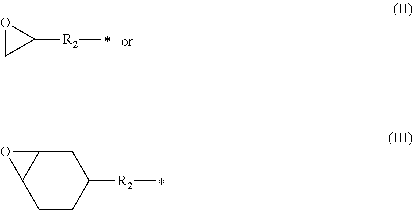

wherein, R₂ is an alkylene group or a heteroalkylene group having at least one oxygen heteroatom.

Item 19 is the method of any one of items 16 to 18, characterized in that, the silsesquioxane polymer comprising the second epoxy-containing group has the following formula (IV):

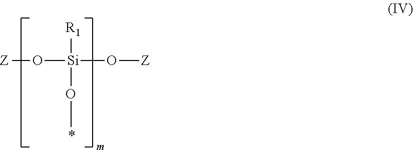

wherein, Z is hydrogen or a group having a structure of —Si(R₃)₍₃₋ₓ₎(R₄)ₓ. Group R₃ is alkyl; group R₄ is hydroxy, or an oxygen-containing group linking group Z to second silicon atom in the silsesquioxane polymer; x is an integer with a value of 0, 1, or 2; and m is an integer greater than or equal to 3.

Item 20 is the method of any one of items 16 to 19, characterized in that, the content of the monomeric unit having the first epoxy-containing group is greater than 0.1 and less than or equal to 1 wt. %, calculated based on the total weight of the poly(meth)acrylate copolymer as 100 wt. %.

Item 21 is the method of any one of items 16 to 20, characterized in that, the poly(meth)acrylate copolymer has a glass transition temperature between −25° C. and −10° C.

Item 22 is the method of any one of items 16 to 21, characterized in that, the poly(meth)acrylate copolymer has a glass transition temperature between −20° C. and −15° C.

Item 23 is the method of any one of items 16 to 22, characterized in that, the poly(meth)acrylate copolymer has a weight average molecular weight between 300,000 and 450,000 Da.

Item 24 is the method of any one of items 16 to 23, characterized in that, the silsesquioxane polymer has a content from 5 to 25 wt. %, calculated based on the total weight of the poly(meth)acrylate copolymer as 100 wt. %.

Item 25 is the method of any one of items 16 to 24, characterized in that, the silsesquioxane polymer has a content from 5 to 15 wt. %, calculated based on the total weight of the poly(meth)acrylate copolymer as 100 wt. %.

Item 26 is the method of any one of items 16 to 25, characterized in that, the silsesquioxane polymer has a weight average molecular weight from 1,000 to 50,000 Da, and a glass transition temperature greater than −50° C. and less than or equal to 0° C.

Item 27 is the method of any one of items 16 to 26, characterized in that, the cationic photocatalyst has a content from 1 to 3 wt. %, calculated based on the total weight of the poly(meth)acrylate copolymer as 100 wt. %.

Item 28 is the method of any one of items 16 to 27, characterized in that, the cationic photocatalyst includes at least one of the following compounds: onium salt or a cationic organometallic salt.

Item 29 is a method of preparing a cured adhesive composition, wherein the method includes preparing a curable adhesive composition as in any one of items 16 to 28 and exposing the curable adhesive composition to ultraviolet and/or visible radiation to form the cured adhesive composition.

Item 30 is a curable adhesive composition that can be cured with UV and/or visible radiation, the curable adhesive composition that includes (1) a UV curable poly(meth)acrylate copolymer comprising a monomeric unit having a first epoxy-containing group, wherein the content of the monomeric unit having the first epoxy-containing group is greater than 0.1 wt. % and less than or equal to 1 wt. %, calculated based on the total weight of the poly(meth)acrylate copolymer as 100 wt. %, and wherein the poly(meth)acrylate copolymer has a glass transition temperature between −30° C. and −10° C.; (2) a silsesquioxane polymer comprising a second epoxy-containing group, wherein the silsesquioxane polymer has a content from 0.5 to 32 wt. %, calculated based on the total weight of the poly(meth)acrylate copolymer as 100 wt. %; and (3) a cationic photocatalyst, wherein the cationic photocatalyst has a content not exceeding 3 wt. %, calculated based on the total weight of the poly(meth)acrylate copolymer as 100 wt. %.

Item 31 is the curable adhesive composition of item 30, wherein the silsesquioxane polymer comprises at least one three-dimensional branched network having at least three repeating units of the following formula (I)

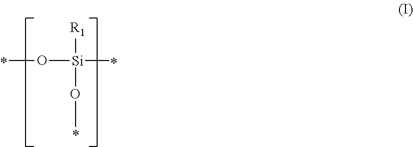

wherein, R₁ is a epoxy-containing group and the asterisk (*) stands for an attachment site to another groups within the silsesquioxane polymer; and the curable adhesive composition still further contains (3) a cationic photocatalyst.

Item 32 is the curable adhesive composition of item 30 or 31, characterized in that, the first epoxy-containing group or the second epoxy-containing group have structures of the following formula (II) or formula (III):

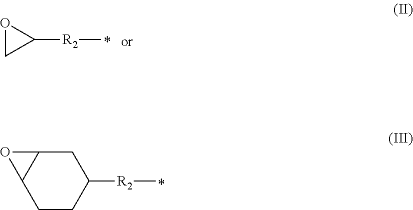

wherein, R₂ is an alkylene group or a heteroalkylene group having at least one oxygen heteroatom.

Item 33 is the curable adhesive composition of any one of items 30 to 32, characterized in that, the silsesquioxane polymer comprising the second epoxy-containing group has the following formula (IV):

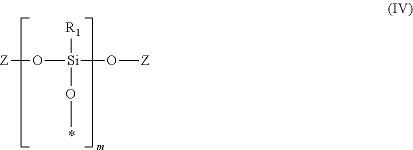

wherein, Z is hydrogen or a group having a structure of —Si(R₃)₍₃₋ₓ₎(R₄)ₓ. Group R₃ is alkyl; group R₄ is hydroxy, or an oxygen-containing group linking group Z to second silicon atom in the silsesquioxane polymer; x is an integer with a value of 0, 1, or 2; and m is an integer greater than or equal to 3.

Item 34 is the curable adhesive composition of any one of items 30 to 33, characterized in that, the poly(meth)acrylate copolymer has a glass transition temperature between −25° C. and −10° C.

Item 35 is the curable adhesive composition of any one of items 30 to 34, characterized in that, the poly(meth)acrylate copolymer has a glass transition temperature between −20° C. and −15° C.

Item 36 is the curable adhesive composition of any one of items 30 to 35, characterized in that, the poly(meth)acrylate copolymer has a weight average molecular weight between 300,000 and 450,000 Da.

Item 37 is the curable adhesive composition of any one of items 30 to 36, characterized in that, the silsesquioxane polymer has a content from 5 to 25 wt. %, calculated based on the total weight of the poly(meth)acrylate copolymer as 100 wt. %.

Item 38 is the curable adhesive composition of any one of items 30 to 37, characterized in that, the silsesquioxane polymer has a content from 5 to 15 wt. %, calculated based on the total weight of the poly(meth)acrylate copolymer as 100 wt. %.

Item 39 is the curable adhesive composition of any one of items 30 to 38, characterized in that, the silsesquioxane polymer has a weight average molecular weight from 1,000 to 50,000 Da, and a glass transition temperature greater than −50° C. and less than or equal to 0° C.

Item 40 is the curable adhesive composition of any one of items 30 to 39, characterized in that, the cationic photocatalyst has a content from 1 to 3 wt. %, calculated based on the total weight of the poly(meth)acrylate copolymer as 100 wt. %.

Item 41 is the curable adhesive composition of any one of items 30 to 40, characterized in that, the cationic photocatalyst includes at least one of the following compounds: onium salt or a cationic organometallic salt.

Item 42 is a cured adhesive composition comprising a reaction product obtained by exposing a curable composition of any one of items 30 to 41 to ultraviolet and/or visible radiation.

Item 43 is an adhesive tape comprising a substrate and a layer of a cured adhesive composition of item 42 on a surface of the substrate.

Item 44 is an adhesive tape comprising a substrate and a layer of a curable adhesive composition of any one of items 30 to 41 on a surface of the substrate.

Item 45 is an article comprising at least one substrate and the cured adhesive composition of item 42 on at least one surface of the at least one substrate.

Item 46 is an article comprising a substrate and a curable adhesive composition on at least one surface of the substrate, wherein the curable adhesive composition is any one of items 1 to 12 or items 30 to 39.

### EXAMPLES

The present invention will be illustrated below in more details in conjunction with examples, but the present invention is not limited to these examples.

### Raw Materials

Raw materials employed in examples of the present invention are as listed in Table 1:

TABLE 1

| Name or | | |
|---|---|---|
| abbreviation | Description | Manufacturer |
| BA | 2-ethylhexyl acrylate n-butyl | HuaYi |
| | acrylate | |
| MA | Methyl acrylate | HuaYi |
| AA | Acrylic acid | Huayi |
| VAZO-67 | Trade designation for | Dopout |
| | azodiisobutyronitrile initiator | |
| GMA | Glycidyl methacrylate | Sartomer |
| KH560 | Trade designation for | Sinopharm |
| | Dimethyldimethoxy silane | Chemical |
| | blocking agent | Reagent |
| Dimethyl- | Dimethyldimethoxy silicon | Sinopharm |
| dimethoxysilane | | Chemical |
| | | Reagent |
| DOUBLECURE | Sulfonium hexafluoroantimonate | Double Bond |
| 1176 | salt, which is | Chemical Ind. |
| | diphenyl(4-phenylthio)phenyl- | Co., Ltd. |
| | sulfonium hexafluoroatimonate | |
| EtoAC | Ethyl acetate | Huayi |
| IPA | Isopropanol | Huayi |

### Testing Methods

### Test of Peel Strength at a 180° Angle at Room Temperature

The adhesive tape prepared was cut into ½-inch sample strips, a release film was peeled off, and the sample strips were stuck, employing a rubber roller, onto a 2-mm thick glass that has been cleaned in advance with isopropanol. The glass with the UV cured adhesive composition adhesive tape stuck thereon was placed into a UV curing machine for curing. The UV ray was set to irradiate to the adhesive layer of the UV curable adhesive composition through a surface of the glass. In this process, the UV energy absorbed by the adhesive layer was tested, using a UV energy meter (ETI UV Power Puck), to be 1200 mJ @ UVA. After UV irradiation, a series of the glasses with the adhesive tapes of the UV cured adhesive composition stuck thereon were placed for different time, and tested for the 180°-angle peel strength at room temperature, by employing an INSTRON material testing machine.

### Peel Strength Test at a 1800 Angle at 70° C.

The glasses with the adhesive tapes of the UV cured adhesive composition stuck thereon were placed at room temperature for 2 weeks after UV irradiation, for use in this test. In the test, the samples were placed into an oven at 70° C., and stayed for 20 min. Then, the 180°-angle peel strength was tested directly in the oven, employing a CHATILLON hand-held tensile machine.

### Over-Lap Shear Strength Test

The UV curable adhesive composition was prepared as 40-μm thick adhesive films, cut up into 1 inch×½ inch films, and stuck onto an end face of a 1 inch×5 inches×0.12 inch aluminum plate that had been cleaned with IPA. Then, the films were placed into a UV curing machine for curing, in which process, the UV ray was directly radiated to the adhesive surface, and the UV energy absorbed by the adhesive layer was tested, using a UV energy meter (ETI UV Power Puck), to be 1200 mJ @ UVA. After UV irradiation, another piece of 1 inch×5 inches×0.12 inch aluminum plate without the adhesive film stuck thereon that has been cleaned with IPA was rapidly over-lapped onto an adhesive surface of a UV irradiated aluminum plate, and placed for 2 weeks at room temperature under a pressure applied. During the shear strength test, the aluminum sheets on both ends of the over-lapped samples were clamped with clamps, to test the tensile strength thereof in a forward direction, employing the INSTROM material testing machine.

### Preparation of the Silsesquioxane Polymer Containing the Epoxy Group

150 grams of 3-glycidoxypropyltrimethoxysilane was added into 50 grams of deionized water. This mixture was stirred for 1 hour at 70° C. Then 7.5 grams of a dimethyldimethoxy silane blocking agent was added therein, and further stirred for 3 hours at 70° C. Subsequently, a mixed water/ethanol solution was removed from the system by evaporization, thereby to obtain a sticky silsesquioxane polymer containing an epoxy group. Then, this sticky silsesquioxane polymer containing the epoxy group was diluted with ethyl acetate, thereby to obtain a mixture of the silsesquioxane polymer containing the epoxy group/ethyl acetate with a solid content of 30 wt. %.

### Preparation of the UV Curable Poly(Meth)Acrylate Copolymer Containing Monomeric Units Having an Epoxy Group

440 grams of butyl acrylate (BA), 495 grams of methyl acrylate (MA), 60 grams of acrylic acid (AA), 5 grams of glycidyl methacrylate (GMA) and 36 grams of isopropanol (IPA) were mixed with 1400 grams of an ethyl acetate solvent (EtoAC), added into a reaction kettle, vacuumized, and purged with N₂, and the temperature was raised to 60° C. Subsequently, 1 grams of an initiator VAZO 67 was dissolved into 32 grams of EtoAC, and purged with N₂ to remove oxygen, and added into the reaction kettle. The reaction temperature was controlled at 60±1° C., and the mixture was stirred and subjected to reaction. When the reaction was proceeded to 1 hour and 4 hours, samples were taken respectively, to test the solid content and inherent viscosity thereof. The remaining 1 gram of VAZO 67 was dissolved into 32 grams of EtoAC, purged with N₂ to remove oxygen, and then added into the reaction kettle. The reaction temperature was controlled at 65±1° C., and the reaction was further carried out for 9 hours before termination, to obtain the poly(meth)acrylate copolymer with a solid content of 40%. The intrinsic viscosity was

### Preparation of the Curable Adhesive Composition

Various curable adhesive compositions were prepared by mixing together the UV curable poly(meth)acrylate copolymer containing epoxy groups, the silsesquioxane polymer containing epoxy groups, and a photocatalyst.

The above UV curable poly(meth)acrylate copolymer containing monomeric units having an epoxy group (which can be referred to as a poly(meth)acrylate copolymer having epoxy groups or as a UV curable poly(meth)acrylate copolymer) had undergone solution polymerization and contained acrylic acid chain segments. The epoxy group monomeric units were glycidyl methacrylate (GMA), with a part by weight thereof at 0.5 wt. %. The poly(meth)acrylate copolymer formed had a glass transition temperature (Tg) of about −20° C., and an inherent viscosity (I.V.) of about 1.25.

The above silsesquioxane polymer containing an epoxy group (epoxy-SSQ) was prepared by controllable sol-gel reaction of 3-glycidoxypropyltrimethoxysilane, and dissolved in an ethyl acetate solvent, at a solid content of 30 wt. %. The weight average molecular weight of this material was 4000 Da. The glass transition temperature (Tg) was −30° C.

The ultraviolet curing reaction was carried out with the initiation by a cationic photocatalyst. The cationic photocatalyst used in the present invention was sulfonium hexafluoroantimonate salts, which can generate protonic acid under the ultraviolet irradiation with a specific wavelength, thereby initiating the cationic polymerization reaction.

### Example 1

20.393 grams of the above UV curable poly(meth)acrylate copolymer, 0.136 grams of the silsesquioxane polymer containing an epoxy group, and 0.163 grams of a sulfonium hexafluoroantimonate cationic photoinitiator (DOUBLECURE 1176, 50% solid, obtained from Double Bond Chemical) were mixed with 9.308 grams of an ethyl acetate solvent for 1 hour to be homogeneous and transparent, thereby to prepare the UV curable adhesive composition.

### Example 2

20.03 grams of the above UV curable poly(meth)acrylate copolymer, 0.534 grams of the silsesquioxane polymer containing the epoxy group, and 0.160 grams of DOUBLECURE 1176 were mixed with 9.276 grams of an ethyl acetate solvent for 1 hour to be homogeneous and transparent, thereby to prepare the UV curable adhesive composition. Cured adhesive compositions were prepared as described above in the testing methods.

### Example 3

13.043 grams of the above UV curable poly(meth)acrylate copolymer, 0.696 grams of the silsesquioxane polymer containing the epoxy group, and 0.104 grams of DOUBLECURE 1176 were mixed with 6.157 grams of an ethyl acetate solvent for 1 hour to be homogeneous and transparent, thereby to prepare the UV curable adhesive composition. Cured adhesive compositions were prepared as described above in the testing methods.

### Example 4

12.466 grams of the above UV curable poly(meth)acrylate copolymer, 1.330 grams of the silsesquioxane polymer containing the epoxy group, and 0.1 grams of DOUBLECURE 1176 were mixed with 6.105 grams of an ethyl acetate solvent for 1 hour to be homogeneous and transparent, thereby to prepare the UV curable adhesive composition. Cured adhesive compositions were prepared as described above in the testing methods.

### Example 5

12.688 grams of the above UV curable poly(meth)acrylate copolymer, 5.414 grams of the silsesquioxane polymer containing the epoxy group, and 0.102 grams of DOUBLECURE 1176 were mixed with 11.797 grams of an ethyl acetate solvent for 1 hour to be homogeneous and transparent, thereby to prepare the UV curable adhesive composition. Cured adhesive compositions were prepared as described above in the testing methods.

### Comparative Example 1

13.678 grams of the above UV curable poly(meth)acrylate copolymer and 0.109 grams of DOUBLECURE 1176 were mixed with 6.213 grams of an ethyl acetate solvent for 1 hour to be homogeneous and transparent, thereby to prepare the UV curable adhesive composition. Cured adhesive compositions were prepared as described above in the testing methods.

### Comparative Example 2

As a reference, a methylacryloyloxysilicone polymer (Methacryl-SSQ) was prepared at the same time.

2643 grams of methylacryloyloxytrimethoxy silane was mixed with 1000 grams of deionized water and 5 grams of hydrochloric acid (37%). This mixture was stirred at room temperature until a heat liberation phenomenon had occurred, and further mixed for 5 min, then 289.5 grams of hexamethyldisiloxane was added into the system. Then, this mixture was further stirred for 8 h at 30° C. Subsequently, a mixed water/ethanol solution was removed from the system by evaporization, thereby to obtain a sticky methylacryloyloxy silicone polymer (Methacryl-SSQ). Subsequently, this sticky methylacryloyloxy silicone polymer was dissolved into 500 ml of a butanone solvent, and then washed once with 800 ml of deionized water. Then this mixed butanone/water solution was evaporated, thereby to obtain a methylacryloyloxy silicone polymer with a solid content of 100%.

22.119 grams of the above UV curable poly(meth)acrylate copolymer, 0.044 grams of Methacryl-SSQ, 0.177 grams of DOUBLECURE 1176, and 0.022 grams of a free radical photoinitiator (IRGACURE TPO, obtained from BASF Chemical) were mixed with 17.638 grams of an ethyl acetate solvent for 1 hour to be homogeneous and transparent, thereby to prepare the UV curable adhesive composition. Cured adhesive compositions were prepared as described above in the testing methods.

### Comparative Example 3

21.635 grams of the above UV curable poly(meth)acrylate copolymer, 0.173 grams of Methacryl-SSQ, 0.173 grams of DOUBLECURE 1176, 0.087 g of a free radical photoinitiator (IRGACURE TPO) were mixed with 17.933 grams of an ethyl acetate solvent for 1 hour to be homogeneous and transparent, thereby to prepare the UV curable adhesive composition. Cured adhesive compositions were prepared as described above in the testing methods.

### Comparative Example 4

21.028 grams of the above UV curable poly(meth)acrylate copolymer, 0.336 grams of Methacryl-SSQ, 0.168 grams of DOUBLECURE 1176, and 0.168 grams of a free radical photoinitiator (IRGACURE TPO, BASF Chemical) were mixed with 18.299 grams of an ethyl acetate solvent for 1 hours to be homogeneous and transparent, thereby to prepare the UV curable adhesive composition Cured adhesive compositions were prepared as described above in the testing methods.

### Comparative Example 5

19.912 grams of the above UV curable poly(meth)acrylate copolymer, 0.637 grams of Methacryl-SSQ, 0.159 grams of DOUBLECURE 1176, and 0.319 g of a free radical photoinitiator (IRGACURE TPO, BASF Chemical) were mixed with 18.793 grams of an ethyl acetate solvent for 1 hour to be homogeneous and transparent, thereby to prepare the UV curable adhesive composition. Cured adhesive compositions were prepared as described above in the testing methods.

### Comparative Example 6

16.63 grams of the above UV curable poly(meth)acrylate copolymer, 0.03 grams of 3-glycidoxypropyltrimethoxysilane (KH-560), and 0.13 grams of DOUBLECURE 1176 were mixed with 13.21 grams of an ethyl acetate solvent for 1 hour to be homogeneous and transparent, thereby to prepare the UV curable adhesive composition. Cured adhesive compositions were prepared as described above in the testing methods.

### Comparative Example 7

16.38 grams of the above UV curable poly(meth)acrylate copolymer, 0.13 g of 3-glycidoxypropyltrimethoxysilane (KH-560), and 0.13 g of DOUBLECURE 1176 were mixed with 13.35 grams of an ethyl acetate solvent for 1 hour to be homogeneous and transparent, thereby to prepare the UV curable adhesive composition. Cured adhesive compositions were prepared as described above in the testing methods.

### Comparative Example 8

15.48 grams of the above UV curable poly(meth)acrylate copolymer, 0.5 grams of 3-glycidoxypropyltrimethoxysilane (KH-560), and 0.12 grams of DOUBLECURE 1176 were mixed with 13.90 grams of an ethyl acetate solvent for 1 hour to be homogeneous and transparent, thereby to prepare the UV curable adhesive composition. Cured adhesive compositions were prepared as described above in the testing methods.

### Preparation of Adhesive Tapes Containing the UV Cured Adhesive Composition

The UV curable adhesive compositions from the examples and comparative examples were coated onto 75-μm (75 micrometer) thick polyethylene terephthalate (PET) films, and dried by an oven, to form 40-μm (40 micrometer) thick adhesive layers. The 75-μm thick PET release films were covered with the adhesive layers, thereby to prepare adhesive tapes containing the UV curable adhesive compositions. The UV curable adhesive compositions were exposed to UV radiation to form the UV cured adhesive composition as described above in the testing methods.

Performance Evaluation after Curing with UV Radiation

TABLE 5
Test of peel strength at a 180° angle at room temperature

| | Peel strength at a 180°- |
|---|---|
| Samples | angle at room temperature (N/mm) |
| Comparative example 1 | 0.64 |
| Example 1 | 1.52 |
| Example 2 | 1.73 |
| Example 3 | 1.89 |
| Example 4 | 1.86 |
| Example 5 | 1.47 |
| Comparative example 2 | 0.95 |
| Comparative example 3 | 1.00 |
| Comparative example 4 | 1.04 |
| Comparative example 5 | 0.78 |
| Comparative example 6 | 1.55 |
| Comparative example 7 | 1.56 |
| Comparative example 8 | 1.58 |

TABLE 6
Test of peel strength at a 180° angle at 70° C.

| | Peel strength at a 180°- |
|---|---|
| Samples | angle at 70° C. (N/mm) |
| Comparative example 1 | 0.95 |
| Example 1 | 1.06 |
| Example 2 | 1.10 |
| Example 3 | 1.77 |
| Example 4 | 1.80 |
| Comparative example 1 | 0.93 |
| Comparative example 2 | 0.95 |
| Comparative example 3 | 0.94 |

TABLE 7
Test of Al-Al over-lap shear strength at room temperature

| Sample | Mpa |
|---|---|
| Example 4 | 2.66 |

The present invention has been described above in a manner of exemplification. However, those of skill in the art will understand that the present invention is not limited to the above particular examples.

Further, it is to be understood that, the compounds, compositions, parts, devices and/or methods disclosed and described in the present invention are not limited to the particular synthetic methods (unless otherwise stated) or particular reagents (unless otherwise stated), because they can be varied.

It is to be further understood that, a lot of values have been disclosed herein, and each of the values is disclosed herein in a manner of “about” that particular value, in addition to the value itself. It is to be further understood that, each end point of a range is meaningful when it is associated with or independent from the other end point. All numerical ranges represented by the end point values included herein comprise the end point values of the ranges, and wherein all the end point values can be combined, and numerical ranges after the combination are also within the scope of the present invention. Advantages of the present invention are further illustrated in the above non-limiting examples. However, the particular materials and amount thereof used, and other experimental conditions employed in the examples should not be understood as limiting the present invention. Unless otherwise specified, all parts, percentages, ratios and the like are by weight.

1. A curable adhesive composition comprising:
(1) a UV curable poly(meth)acrylate copolymer comprising a monomeric unit having a first epoxy-containing group, wherein the poly(meth)acrylate copolymer has a glass transition temperature between −30° C. and −10° C.;
(2) a silsesquioxane polymer comprising a second epoxy-containing group, the silsesquioxane polymer comprising at least one three-dimensional branched network having at least three repeating units of the following formula (I) 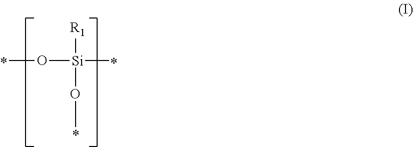
wherein
R₁ is the second epoxy-containing group; and
* stands an attachment site to another group within the silsequioxane polymer; and
(3) a cationic photocatalyst.

2. The curable adhesive composition of claim 1, characterized in that, the first epoxy-containing group or the second epoxy-containing group have structures of the following formula (II) or formula (III): 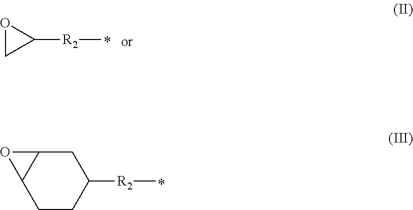
wherein, R₂ is an alkylene group or a heteroalkylene group having at least one oxygen heteroatom.

3. The curable adhesive composition of claim 1, characterized in that, the silsesquioxane polymer comprising the second epoxy-containing group has the following formula (IV): 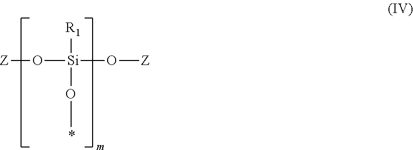
wherein,
Z is hydrogen or a group having a structure of —Si(R₃)₍₃₋ₓ₎(R₄)ₓ;
R₃ is alkyl;
R₄ is hydroxy, or an oxygen-containing group linking group Z to second silicon atom in the silsesquioxane polymer;
x is an integer with a value of 0, 1, or 2;
and m is an integer greater than or equal to 3.

4. The curable adhesive composition of claim 1, characterized in that, the content of the monomeric unit having the first epoxy-containing group is greater than 0.1 and less than or equal to 1 wt. %, calculated based on the total weight of the poly(meth)acrylate copolymer as 100 wt. %.

5. The curable adhesive composition of claim 1, characterized in that, the poly(meth)acrylate copolymer has a glass transition temperature between −25° C. and −10° C.

6. The curable adhesive composition of claim 1, characterized in that, the poly(meth)acrylate copolymer has a weight average molecular weight between 300,000 and 450,000 Da.

7. The curable adhesive composition of claim 1, characterized in that, the silsesquioxane polymer has a content from 5 to 25 wt. %, calculated based on the total weight of the poly(meth)acrylate copolymer as 100 wt. %.

8. The curable adhesive composition of claim 1, characterized in that, the silsesquioxane polymer has a content from 5 to 15 wt. %, calculated based on the total weight of the poly(meth)acrylate copolymer as 100 wt. %.

9. The curable adhesive composition of claim 1, characterized in that, the silsesquioxane polymer has a weight average molecular weight from 1,000 to 50,000 Da and a glass transition temperature greater than −40° C. and less than or equal to 10° C.

10. The curable adhesive composition of claim 1, characterized in that, the cationic photocatalyst has a content from 1 to 3 wt. %, calculated based on the total weight of the poly(meth)acrylate copolymer as 100 wt. %.

11. A cured adhesive composition comprising a reaction product obtained by exposing a curable composition of claim 1 to ultraviolet and/or visible radiation.

12. An article comprising a substrate and the curable adhesive composition on at least one surface of the substrate, wherein the curable adhesive composition is according to claim 1.

13. An article comprising a substrate and the cured adhesive composition on at least one surface of the substrate, wherein the cured adhesive composition is according to claim 11.

14. A curable adhesive composition, including:
a UV curable poly(meth)acrylate copolymer comprising a monomeric unit having a first epoxy-containing group, wherein the content of the monomeric unit having the first epoxy-containing group is greater than 0.1 wt. % and less than or equal to 1 wt. %, calculated based on the total weight of the poly(meth)acrylate copolymer as 100 wt. %, and the poly(meth)acrylate copolymer has a glass transition temperature between −30° C. and −10° C.;
a silsesquioxane polymer containing comprising a second epoxy-containing group, wherein the silsesquioxane polymer has a content from 0.5 to 32 wt. %, calculated based on the total weight of the poly(meth)acrylate copolymer as 100 wt. %;
and a cationic photocatalyst, wherein the cationic photocatalyst has a content not exceeding 3 wt. %, calculated based on the total weight of the poly(meth)acrylate copolymer as 100 wt. %.

15. A cured adhesive composition comprising a reaction product obtained by placing a curable adhesive composition under UV and/or visible radiation, wherein the curable adhesive composition is the curable adhesive composition is of claim 14.
